(19) United States
(12) Patent Application Publication
(10) Pub. No.: US 2021/0334114 A1
(43) Pub. Date: Oct. 28, 2021

(54) Method And Storage Medium For Realizing Interaction Between Business Systems And At Least One Component

(71) Applicant: Ping An Technology (Shenzhen) Co., Ltd., Guangdong (CN)

(72) Inventor: Zheng Lu, Shenzhen (CN)

(21) Appl. No.: 16/315,254

(22) PCT Filed: Feb. 27, 2018
(86) PCT No.: PCT/CN2018/077420

§ 371 Date: Jan. 4, 2019

(30) Foreign Application Priority Data
Sep. 11, 2017 (CN) 201710814312X

(51) Int. Cl. G06F 9/451; G06F 9/445; G06F 8/38; G06F 3/0481; G06F 3/0482; G06F 3/0484

(52) U.S. Cl. CPC G06F 9/451; G06F 9/44505; G06F 3/04847; G06F 3/04817; G06F 3/0482; G06F 8/38

(57) ABSTRACT

A method for realizing interaction between a business system and at least one component. Steps include configuring at least one component in a frame system; displaying the frame system configured with the components on the front page of the main business system; by clicking on components displayed on the front page of the main business system, a user jumping from the main business system and logging to a front page of another business system defined by each of the clicked components.

This present disclosure declares priority of the Chinese patent application with number 201710814312.X, filed on Sep. 11, 2017, entitled “Method, electronic devices and storage medium for realizing interaction between business systems and multiple components”. Entire content of the Chinese patent application is incorporated in the present disclosure by reference.

### BACKGROUND

### 1. Technical Field

The invention relates to a construction method of an intermediate platform, in particular to a method for realizing the interaction between a business system and multiple components, an electronic device and a storage medium.

### 2. Background Information

In a field of remote customer contact (sales, services), different business scenarios (such as production, life, investment, credit, banking, etc.) have different business processes, and business systems are very different, but they all use some common components, such as soft phone, video, audio, customer portraits, electronic maps, knowledge base, robots and other components.

Originally, each business system is interacted with these components separately, but due to different technologies and standards, all business systems and components needed some customized development, of which workload is heavy, communication efficiency is low, and later maintenance cost is high.

In order to simplify the workload of development and later maintenance, the interaction between the business system and the common components is realized by putting the business system and the common components under the same framework. However, this method is too intrusive to the business system (such as changing the domain name of the user accessing the business system, the user needs to apply for framework permissions, etc.), which is not acceptable by many business systems.

Therefore, how to facilitate the business system and various components to achieve interaction, while reducing development and maintenance workload, has become an outstanding technical problem.

### SUMMARY

Technical problem to be solved by the present disclosure is to overcome the problem of being too intrusive to the business system caused by realizing interaction between the business system and the common components in the prior art. This disclosure presents a method, electronic device and storage medium for realizing the interaction between business system and multiple components. The components are embedded in the business system in the form of plug-in-like to realize the quick docking between the business system and each component with low development workload.

The present disclosure addresses the above technical issues through the following technical solutions:

a method for realizing the interaction between a business system and multiple components, which includes the following steps: S1, configuring at least one component in a frame system; S2, displaying the frame system configured with the components on the front page of the main business system; S3, by clicking on components displayed on the front page of the main business system, a user jumping from the main business system and logging to a front page of another business system defined by the clicked component;

an electronic device, which includes a memory and a processor, wherein a system which can be executed by the processor for realizing the interaction between a business system and multiple components is stored in the memory, wherein the system for realizing the interaction between the business system and the multiple components comprises: a combination module, for defining combined components and manage the components; a front display module for displaying the combined components on the front page of the main business system; and a detection access module, for after detecting a component displayed on a front page of the main business system being clicked, opening and logging to a front page of another business system defined by the clicked component;

a computer-readable storage medium in which a system for realizing interaction between a business system and multiple components is stored, and the system for realizing interaction between the business system and the multiple components can be executed by at least one processor, to cause the at least one processor to perform following steps: S1, configuring at least one component in a frame system; S2, displaying the frame system configured with the components on the front page of the main business system; S3, by clicking on components displayed on the front page of the main business system, a user jumping from the main business system and logging to a front page of another business system defined by the clicked component.

The details of one or more embodiments of present disclosure are set forth in the accompanying drawings and the description below. Other potential features, objects, and advantages of the present disclosure will become apparent from the description, the drawings, and the claims.

### BRIEF DESCRIPTION OF THE DRAWINGS

FIG. 1 shows a schematic diagram of hardware architecture of an electronic device according to an embodiment of the present disclosure;

FIG. 2 shows a schematic diagram of a program module of a system for realizing interaction between a business system and multiple components in the electronic device according to an embodiment of the present disclosure;

FIG. 3 shows a flowchart of a method for realizing interaction between a business system and multiple components according to an embodiment of the present disclosure;

FIG. 4 shows a flowchart of a method for realizing interaction between a business system and multiple components according to another embodiment of the present disclosure;

FIG. 5 shows a flowchart of requesting logging to VoIP (voice over internet protocol) tool from the main business system in the method for realizing interaction between a business system and multiple components according to an embodiment of the present disclosure;

FIG. 6 shows a flowchart of requesting logging to another business system from the main business system in the method for realizing interaction between a business system and multiple components according to an embodiment of the present disclosure.

### DETAILED DESCRIPTION

The present application is further explained below by means of embodiments without thereby limiting the present disclosure to the said embodiments.

First, the present application provides an electronic device.

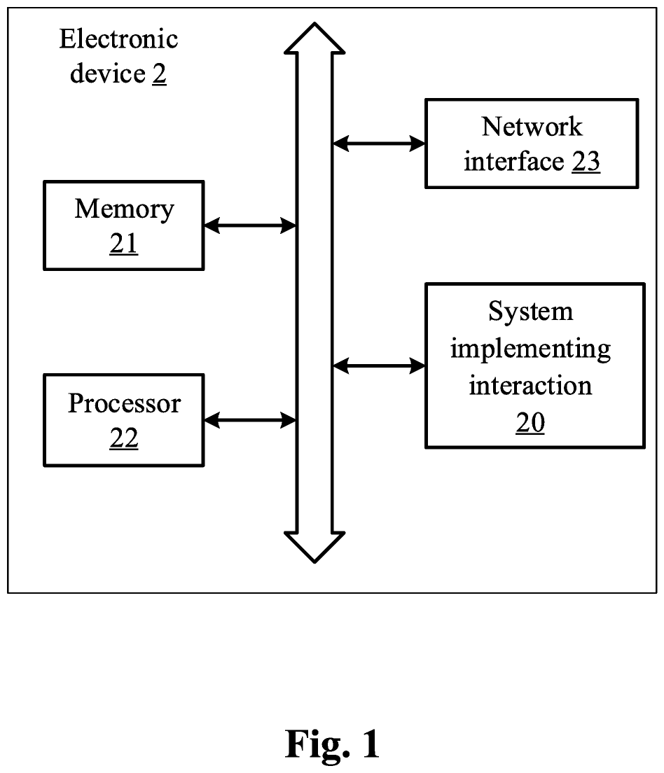

FIG. 1 shows a schematic diagram of the hardware architecture of an electronic device of an embodiment of the present disclosure. In this embodiment, the electronic device 2 is a device capable of automatically performing numerical calculations and/or information processing according to predefined or stored instructions. For example, it can be a Smartphone, tablet, laptop, desktop computer, rack server, blade server, tower server, or cabinet server including stand-alone servers. Or a cluster of multiple servers), and so on. As shown, the electronic device 2 includes, but is not limited to, a memory 21, a processor 22, a network interface 23, and a system for realizing interaction between business systems and multiple components 20 that can be communicated with each other through a system bus. Of which:

The memory 21 includes at least one type of computer-readable storage medium. The readable storage medium includes flash memory, hard disk, multimedia card, card type memory (e.g., SD or DX memory, etc.), random access memory (RAM), static random-access memory (SRAM), read only memory (ROM), electrically erasable. Programmable read-only memory (EEPROM), programmable read-only memory (PROM), magnetic memory, magnetic disk, optical disk, etc. In some embodiments the memory 21 may be an internal storage module of the electronic device 2 such as a hard disk or memory of the electronic device 2. In other embodiments, the memory 21 may also be an external storage device of the electronic device 2, such as a plugged hard disk provided on the electronic device 2, an intelligent memory card (Smart Media Card, SMC), secure digital (Secure Digital, SD) card, a flash memory card (Flash Card), and the like. Of course the memory 21 may also include both an internal storage module and an external storage device of the electronic device 2. In this embodiment, the memory 21 is generally used to store an operating system and various types of application software installed in the electronic device 2 such as the program code of the system for realizing interaction between business systems and multiple components 20 and the like. In addition, the memory 21 may also be used to temporarily store various types of data that have been or will be outputted.

The processor 22 may in some embodiments be a central processor (CPU) a controller a microprocessor or other data processing chip. The processor 22 is generally used to control the overall operation of the electronic device 2 such as performing control and processing related to data interaction or communication with the electronic device 2. In this embodiment, the processor 22 is used to run program code stored in the memory 21 or process data such as running the system for realizing interaction between business systems and multiple components 20 or the like.

The network interface 23 may include a wireless network interface or a wired network interface which is generally used to establish a communication connection between the electronic device 2 and other electronic devices. For example, the network interface 23 is used for connecting the electronic device 2 to an external terminal via a network establishing a data transmission channel and a communication connection between the electronic device 2 and the external terminal. The network can be a wireless or wired network such as an enterprise intranet, an Internet, a Global System of Mobile communication (GSM), a Wideband Code Division Multiple Access (WCDMA), a 4G network, a 5G network, a Bluetooth, Wi-Fi, and the like.

It is to be noted that FIG. 1 shows only an electronic device 2 having components 21-23 but it is understood that it is not required to implement all of the shown components and that more or fewer parts can be implemented in lieu thereof.

In one embodiment, a system 20 for realizing interaction between a business system and multiple components stored in memory 21 may be executed by at least one processor 22 to perform the following steps:

First, it is to configure at least one component in a frame system.

For example, one or more components can be configured in a frame system as needed, particularly, depending on the needs of business person. In general, a business person needs common tools (which can also be understood as business systems, which are uniformly represented as “another business system” in claims), such as the VoIP tool and the Internet chat tool. There may also be a need to use business systems other than the main business system.

Before configuration, these common tools and business systems need to be packaged into components, after then, the components are displayed in the form of icons, such as the VoIP tools displayed as phone graphics icon.

The frame system is displayed as a visual design interface, wherein in particular, configuring at least one component in a frame system is realized by dragging various icons representing the components into the visual design interface representing the frame system, and staying at a specific location of the visual design interface.

Next, the frame system configured with components is displayed on the front page of the main business system.

Specifically, the frame system configured with components is displayed on the front page of the main business system in a form of a floating toolbar, and can also be displayed on the front page of the main business system in a form as embedded in the menu bar of the main business system.

When using the floating toolbar display, it needs to ensure that the floating toolbar is always located on the current page and positioned at the top, position of said floating can be at right side, at left side or in the middle of the bottom of the front page of the main business system, thus ensuring that the information area is not obscured by the floating toolbar, thereby not affecting use by business person.

Preferably, display position of the floating toolbar can be adjusted by the business person using the main business system, so that the display position of the suspension toolbar is more convenient for the use preference of the business person themselves and more humanized. Adjusting the display position herein may be achieved by dragging the floating toolbar.

Finally, by clicking on the component displayed on the front page of the main business system, the user jumps from the main business system and logs on the front page of another business system defined by the component being clicked.

The system in the embodiment realizes the combination of the components on the frame system by dragging icons, which is simple and convenient to operate; in addition, the display position of the components on the front-end web page is flexible and changeable, which can meet the different needs of the business person.

Based on the above embodiments, in another embodiment, in implementing the step of by clicking on the component displayed on the front page of the main business system the user jumping from the main business system and logging on the front page of another business system defined by the component being clicked, the system 20 for realizing interaction between the business system and the multiple components is executed by at least one processor 22, to perform the steps as follows:

Step 1, clicking a component displayed on the front page of the main business system to initiate a business login request of another business system defined by the component to the frame system;

Step 2, the frame system configuring the main business system information and information of the clicked component;

Step 3, the front page of the main business system loading frame system file umaplite.js and unified cross-domain file cross-domain.js provided by the frame system through the HTTP protocol;

Step 4, the main business system initializing the frame system and passing the authentication information for the main business system and the required parameters of the clicked components to the frame system;

Step 5, the frame system verifying whether the business login request is valid, if the verification is passed, returning information of the clicked component configured by the frame system configuration, and the frame system initializing the components configured on the frame system;

Step 6, the framework system requesting the components that have been clicked by jsonp for authentication without login, and if the authentication is passed, the main business system interacting with the clicked components through unified cross-domain technology, realizing “the user jumping from the main business system and logging on the front page of another business system defined by the component being clicked”.

Specifically, the authentication without login described herein means that the frame system directly acquires the account name and password used by the business person when logging in the main business system as the account name and password for another business system defined by the clicked component. That is, when the business person jumps from the main business system to log on to other business systems, it is not required to re-enter the business account name and password for verification, which can be retrieved by the framework system automatically.

It should be noted that the components described herein can be common tools such as VoIP, internet chat, etc., or other business systems similar to the main business system; for the common tools, they can be invoked without login authentication; for the other business systems, the login authentication is required because permission problem may be involved.

The following are described on logging in the VoIP tool from the main business system and jumping and logging in another business system, respectively:

(1) process of requesting access to the VoIP tool from the main business system is as follows:

1, clicking the VoIP icon displayed in floating toolbar on the front page of the main business system, and initiating a business login request on logging on VoIP to the frame system;

2, the frame system configuring information of main business system and the VoIP component.

3, the front page of the main business system loading frame system file umaplite.js and unified cross-domain file cross-domain.js provided by the frame system through the HTTP protocol;

4, the main business system initializing the frame system and passing the authentication information for the main business system and parameters required by VoIP component;

5, the frame system verifying whether the business login request is valid, if the verification is passed, returning information of the clicked component configured by the frame system configuration;

6, the frame system initializing the components configured on the frame system, including VoIP;

7, the frame system requesting the VoIP components by jsonp to log in;

8, the main business system interacts with the VoIP component through the unified cross-domain technology, realizing that the user opening VoIP window directly from the main business system.

(2) process of requesting access to another business system from the main business system is as follows:

1, clicking an icon representing another business system displayed in floating toolbar on the front page of the main business system, and initiating a business login request on logging on another business system to the frame system;

2, the frame system configuring information of main business system and another business system.

3, the front page of the main business system loading frame system file umaplite.js and unified cross-domain file cross-domain.js provided by the frame system through the HTTP protocol;

4, the main business system initializing the frame system and passing the authentication information for the main business system and parameters required by component of another business system;

5, the frame system verifying whether the business login request is valid, if the verification is passed, returning information of the component of another business system configured by the frame system configuration;

6, the frame system initializing the components configured on the frame system, including another business system;

7, the framework system requesting the components of another business system by jsonp for authentication without login, and if the authentication is passed, going to next step, otherwise returning failure information;

8, the main business system interacting with the components of another business system through unified cross-domain technology, realizing “the user jumping from the main business system and logging on the front page of another business system defined”.

Through this embodiment, invocation steps of accessing other components from the main business system in a manner of cross-domain are described in detail, and the cross-domain access objects described herein can be either a common utility type system or other business systems similar to the main business system, with which scope of application is very wide.

Moreover, particularly, when cross-domain access is made to different business systems by the main business system, it will be judged whether or not login authentication is required according to whether the components need access rights, such as common tools such as VoIP tools, which do not need to login authentication, and if another business system is subjected to cross-domain access, it need login authentication, and use an authentication manner without log in with great convenience, to avoid problem that the business person need repeatedly enter the account name and password.

It is to be noted that, in other embodiments, the system 20 for realizing interaction of the business system with multiple components may also be divided into one or more program modules, which are stored in memory 21, and executed by one or more processors (processor 22 in this embodiment) to embody the present disclosure, wherein, the program module referred to in the present disclosure refers to a series of computer program instruction segments capable of accomplishing specific functions.

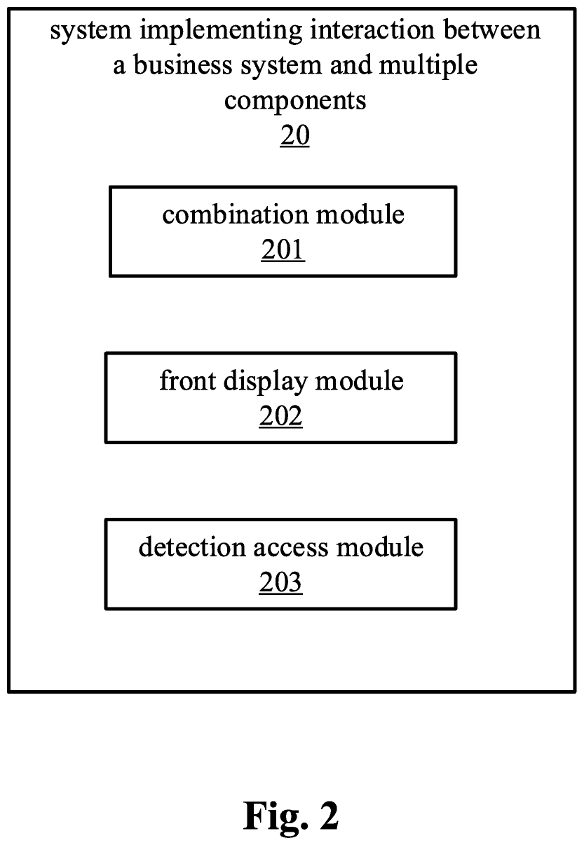

For example, FIG. 2 shows a schematic diagram of a program module of a system for realizing interaction between a business system and multiple components according to an embodiment. The system 20 for realizing interaction between a business system and multiple components can be divided into a combination module 201, a front display module 202, and a detection access module 203. The program modules 201-203 realize functions or operation steps similar to those mentioned above, and will not be described in detail here. For an example:

the combination module 201 is for defining combined components and managing the components;

the front display module 202 is for displaying the combined components on the front page of the main business system;

the detection access module 203 is for after detecting a component displayed on a front page of the main business system being clicked, opening and logging to a front page of another business system.

Further, the present disclosure provided a method for realizing interaction between a business system and multiple components.

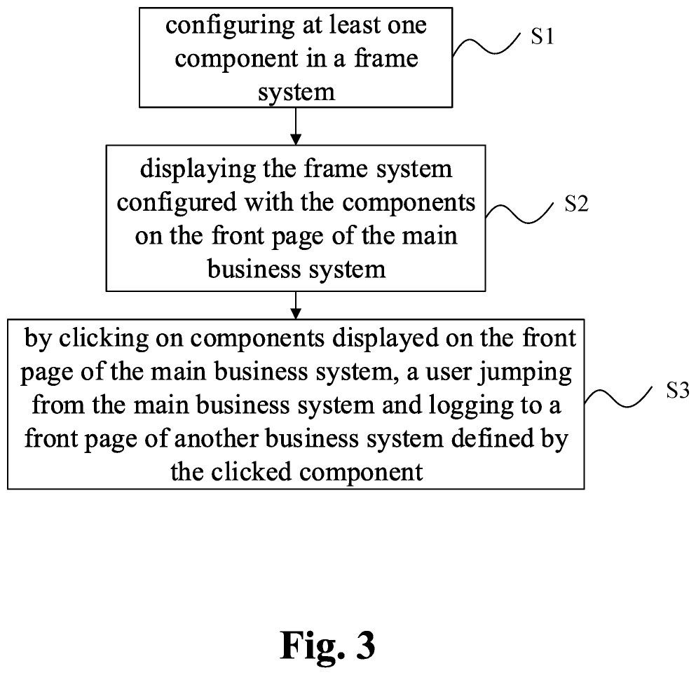

In an embodiment, referring to FIG. 3, the method for realizing interaction between a business system and multiple components comprises steps as following:

S1, configuring at least one component in a frame system;

For example, one or more components can be configured in a frame system as needed, particularly, depending on the needs of business person. In general, a business person needs common tools (which can also be understood as business systems, which are uniformly represented as “another business system” in claims), such as the VoIP tool and the Internet chat tool. There may also be a need to use business systems other than the main business system.

Before the configuration, these common tools and business systems need to be packaged into components, after then, the components are displayed in the form of icons, such as the VoIP tools displayed as phone graphics icon.

The frame system is displayed as a visual design interface, wherein in particular, configuring at least one component in a frame system is realized by dragging various icons representing the components into the visual design interface representing the frame system, and staying at a specific location of the visual design interface.

S2, displaying the frame system configured with components on the front page of the main business system.

Specifically, the frame system configured with components is displayed on the front page of the main business system in a form of a floating toolbar, and can also be displayed on the front page of the main business system in a form as embedded in the menu bar of the main business system.

When using the floating toolbar display, it needs to ensure that the floating toolbar is always located on the current page and positioned at the top, position of said floating can be at right side, at left side or in the middle of the bottom of the front page of the main business system, thus ensuring that the information area is not obscured by the floating toolbar, thereby not affecting use by business person.

Preferably, display position of the floating toolbar can be adjusted by the business person using the main business system, so that the display position of the suspension toolbar is more convenient for the use preference of the business person themselves and more humanized. Adjusting the display position herein may be achieved by dragging the floating toolbar.

S3, by clicking on the component displayed on the front page of the main business system, the user jumping from the main business system and logging on the front page of another business system defined by the component being clicked.

With the method in the embodiment, components are packaged in a standardized way before they are used, then it is realized the combination of the components on the frame system by dragging icons, which is simple and convenient to operate; in addition, after the combination of components, the display position on the front web page is flexible and changeable, and in the late using process, the business person can determine the location of display by themselves, to meet the different needs of business person.

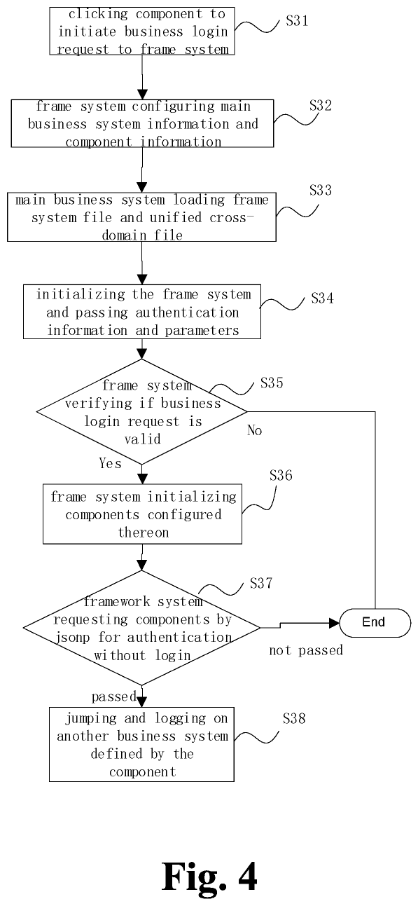

Based on the above embodiments, in another embodiment as shown in FIG. 4 the Step S3 comprises the following sub-steps:

S31, clicking a component displayed on the front page of the main business system to initiate a business login request of another business system defined by the component to the frame system;

S32, the frame system configuring the main business system information and information of the clicked component;

S33, the front page of the main business system loading frame system file umaplite.js and unified cross-domain file cross-domain.js provided by the frame system through the HTTP protocol;

S34, the main business system initializing the frame system and passing the authentication information for the main business system and the required parameters of the clicked components to the frame system.

S35, the frame system verifying whether the business login request is valid, if the verification is passed, returning information of the clicked component configured by the frame system configuration, and going to Step S36;

S36, the frame system initializing the components configured on the frame system;

S37, the framework system requesting the components that have been clicked by jsonp for authentication without login, and if the authentication is passed, going to Step S38;

Specifically, the authentication without login described in Step S37 means that the frame system directly acquires the account name and password used by the business person when logging in the main business system as the account name and password for another business system defined by the clicked component. That is, when the business person jumps from the main business system to log on to other business systems, it is not required to re-enter the business account name and password for verification, which can be retrieved by the framework system automatically.

S38, the main business system interacting with the clicked components through unified cross-domain technology, realizing “the user jumping from the main business system and logging on the front page of another business system defined by the component being clicked”.

It should be noted that the components described herein can be common tools such as VoIP, internet chat, etc., or other business systems similar to the main business system; for the common tools, they can be invoked without login authentication; for the other business systems, the login authentication is required because permission problem may be involved.

The following are described on logging in the VoIP tool from the main business system and jumping and logging in another business system, respectively:

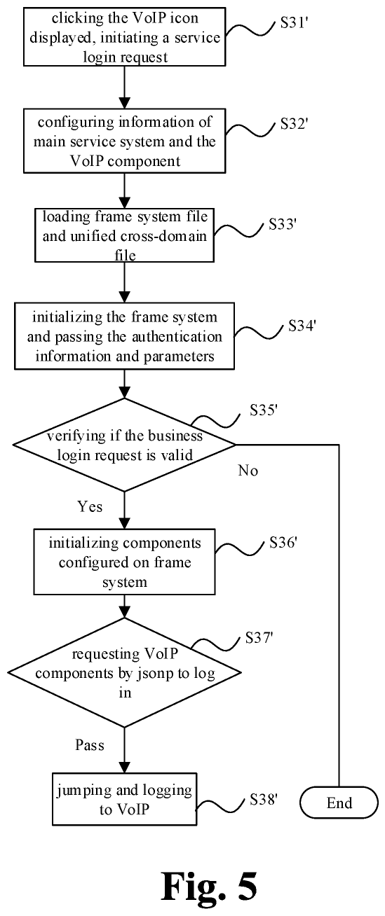

(1) As shown in FIG. 5, process of requesting access to the VoIP tool from the main business system is as follows:

S31′, clicking the VoIP icon displayed in floating toolbar on the front page of the main business system, and initiating a business login request on logging on VoIP to the frame system;

S32′, the frame system configuring information of main business system and the VoIP component;

S33′, the front page of the main business system loading frame system file umaplite.js and unified cross-domain file cross-domain.js provided by the frame system through the HTTP protocol;

S34′, the main business system initializing the frame system and passing the authentication information for the main business system and parameters required by VoIP component;

S35′, the frame system verifying whether the business login request is valid, if the verification is passed, returning information of the clicked component configured by the frame system configuration;

S36′, the frame system initializing the components configured on the frame system, including VoIP;

S37′, the frame system requesting the VoIP components by jsonp to log in;

S38′, the main business system interacts with the VoIP component through the unified cross-domain technology, realizing that the user opening VoIP window directly from the main business system.

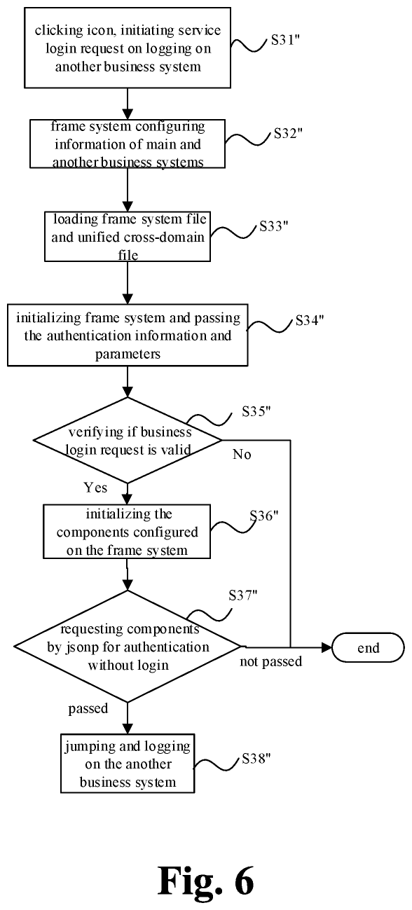

(2) As shown in FIG. 6, process of requesting access to another business system from the main business system is as follows:

S31″, clicking an icon representing another business system displayed in floating toolbar on the front page of the main business system, and initiating a business login request on logging on another business system to the frame system;

S32″, the frame system configuring information of main business system and another business system.

S33″, the front page of the main business system loading frame system file umaplite.js and unified cross-domain file cross-domain.js provided by the frame system through the HTTP protocol;

S34″, the main business system initializing the frame system and passing the authentication information for the main business system and parameters required by component of another business system;

S35″, the frame system verifying whether the business login request is valid, if the verification is passed, returning information of the component of another business system configured by the frame system configuration;

S36″, the frame system initializing the components configured on the frame system, including another business system;

S37″, the framework system requesting the components of another business system by jsonp for authentication without login, and if the authentication is passed, going to next step, otherwise returning failure information;

S38″, the main business system interacting with the components of another business system through unified cross-domain technology, realizing “the user jumping from the main business system and logging on the front page of another business system defined”.

Through interaction method of this embodiment, invocation steps of accessing other components from the main business system in a manner of cross-domain are described in detail.

By configuring and initializing components, the frame system formulates and verifies access standards to enable components to be accessed in accordance with the standards; in addition, the cross-domain access objects described herein can be either a common utility type system or other business systems similar to the main business system, with which scope of application is very wide.

Moreover, when cross-domain access is made to different business systems by the main business system, the system of common tool type can be opened directly without login and authentication, while performing authentication without logging on the business system which needs login and authentication, which avoids the trouble of repeatedly inputting account number and password by business person, and greatly simplifies the operation steps of business person.

Further, the present disclosure provides a computer-readable storage medium in which a system for realizing interaction between a business system and multiple components is stored, and the system for realizing interaction between the business system and the multiple components can be executed by at least one processor, to cause the at least one processor to embody operation of the method or electronic device for realizing interaction between a business system and multiple components.

Positive effects of the application lie in that the application introduces the frame system to realize the docking and interaction between the main business system and each component, and the frame system can solve the standard problem, so that when the business system interacts with each component, once docked with the frame system, various other components can be docked quickly.

While the specific embodiments of the present disclosure are described above it should be understood by those skilled in the art that the scope of protection of the present disclosure is limited by the appended claims only as an example. Those skilled in the art may make a variety of changes or modifications to these embodiments without departing from the principles and substance of the present disclosure but these changes and modifications fall within the scope of protection of the present application.

1. A method for realizing an interaction between a business system and a component comprising:
step S1, configuring the component in a frame system;
step S2, displaying the frame system configured with the component on a page of the main business system; and
step S3, jumping from the main business system and logging on to a page of a second business system by clicking the component on the page of the main business system.

2. The method of claim 1, wherein the component in step S1 is packaged at a different business system from the main business system; and
wherein the packaged business system is displayed in the form of icons.

3. The method of claim 2, wherein the packaged business system includes a VoIP tool and an Internet chat tool.

4. The method of claim 1, wherein the frame system configured with the component in step S2 is displayed on a front page of the main business system in a form of one or both of a floating toolbar, and as embedded in a menu bar of the main business system.

5. The method of claim 1, wherein step S3 comprises the following sub-steps:
step S31, clicking the component displayed on the page of the main business system to initiate a business login request of the second business system defined by the component to the frame system;
step S32, the frame system configuring information of the main business system and information of the clicked component;
step S33, the page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the component that has been clicked by jsonp for authentication without login, and if so authenticated, going to step S38; and
step S38, the main business system interacting with the clicked component through unified cross-domain technology, realizing a user jumping from the main business system and logging on to the page of the second business system defined by the component being clicked.

6-9. (canceled)

10. A computer-readable storage medium in which a system for realizing interaction between a business system and at least one component is stored, and the system for realizing interaction between the business system and the at least one component can be executed by at least one processor, to cause the at least one processor to perform following steps:
step S1, configuring the at least one component in a frame system;
step S2, displaying the frame system configured with the components on a front page of the main business system; and
step S3, by clicking on at least one component displayed on the front page of the main business system, a user jumps from the main business system and logs on to a front page of a second business system defined by the clicked component.

11. The computer-readable storage medium as in claim 10, wherein at least one component in step S1 is packaged at a different business system from the main business system; and
wherein the packaged business system is displayed in the form of icons.

12. The computer-readable storage medium as in claim 11, wherein the packaged business system includes a VoIP tool and an Internet chat tool.

13. The computer-readable storage medium as in claim 10, wherein the frame system configured with the component instep S2 is displayed on the front page of the main business system in a form of one or both of a floating toolbar, and as embedded in a menu bar of the main business system.

14. The computer-readable storage medium as in claim 10, wherein step S3 comprises the following sub-steps:
step S31, clicking at least one of the components displayed on the front page of the main business system to initiate a business login request of the second business system defined by the component to the frame system;
step S32, the frame system configuring information of the main business system and information of the clicked component;
step S33, the front page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the component that has been clicked by jsonp for authentication without login, and if so authenticated, going to step S38; and
step S38, the main business system interacting with the clicked component through unified cross-domain technology, realizing a user jumping from the main business system and logging on to the front page of the second business system defined by the component being clicked.

15. The method of claim 2, wherein step S3 comprises the following sub-steps:
step S31, clicking the component displayed on the page of the main business system to initiate a business login request of the second business system defined by the component to the frame system;
step S32, the frame system configuring information of the main business system and information of the clicked component;
step S33, the page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the components that has been clicked by jsonp for authentication without login, and if so authenticated, going to step S38; and
step S38, the main business system interacting with the clicked component through unified cross-domain technology, realizing a user jumping from the main business system and logging on to the page of the second business system defined by the component being clicked.

16. The method of claim 3, wherein step S3 comprises the following sub-steps:
step S31, clicking the component displayed on the page of the main business system to initiate a business login request of the second business system defined by the component to the frame system;
step S32, the frame system configuring information of the main business system and information of the clicked component;
step S33, the page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the components that has been clicked by jsonp for authentication without login, and if so authenticated, going to step S38; and
step S38, the main business system interacting with the clicked component through unified cross-domain technology, realizing a user jumping from the main business system and logging on to the page of the second business system defined by the component being clicked.

17. The method of claim 4, wherein step S3 comprises the following sub-steps:
step S31, clicking the component displayed on the page of the main business system to initiate a business login request of the second business system defined by the component to the frame system;
step S32, the frame system configuring information of the main business system and information of the clicked component;
step S33, the page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the components that has been clicked by jsonp for authentication without login, and if so authenticated, going to step S38; and
step S38, the main business system interacting with the clicked component through unified cross-domain technology, realizing a user jumping from the main business system and logging on to the page of the second business system defined by the component being clicked.

18. The computer-readable storage medium as in claim 11, wherein step S3 comprises the following sub-steps:
step S31, clicking at least one of the components displayed on the front page of the main business system to initiate a business login request of the second business system defined by the component to the frame system;
step S32, the frame system configuring information of the main business system and information of the clicked component;
step S33, the front page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the component that has been clicked by jsonp for authentication without login, and if so authenticated, going to step S38; and
step S38, the main business system interacting with the clicked component through unified cross-domain technology, realizing a user jumping from the main business system and logging on to the front page of the second business system defined by the component being clicked.

19. The computer-readable storage medium as in claim 12, wherein step S3 comprises the following sub-steps:
step S31, clicking at least one of the components displayed on the front page of the main business system to initiate a business login request of the second business system defined by the component to the frame system;
step S32, the frame system configuring information of the main business system and information of the clicked component;
step S33, the front page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the component that has been clicked by jsonp for authentication without login, and if so authenticated, going to step S38; and
step S38, the main business system interacting with the clicked component through unified cross-domain technology, realizing a user jumping from the main business system and logging on to the front page of the second business system defined by the component being clicked.

20. The computer-readable storage medium as in claim 13, wherein step S3 comprises the following sub-steps:
step S31, clicking at least one of the components displayed on the front page of the main business system to initiate a business login request of the second business system defined by the component to the frame system;
step S32, the frame system configuring information of the main business system and information of the clicked component;
step S33, the front page of the main business system loading a frame system file umaplite.js and a unified cross-domain file cross-domain.js provided by the frame system through the HTTP protocol;
step S34, the main business system initializing the frame system and passing authenticated information of the main business system and any required parameters of the clicked component to the frame system;
step S35, the frame system verifying whether the login request is valid, and if valid, returning information of the clicked component configured by the frame system, and going to step S36;
step S36, the frame system initializing the component configured on the frame system;
step S37, the framework system requesting the component that has been clicked by jsonp for authentication without login, and if so authenticated, going to step S38; and
step S38, the main business system interacting with the clicked component through unified cross-domain technology, realizing a user jumping from the main business system and logging on to the front page of the second business system defined by the component being clicked.
